(19) United States
(12) Patent Application Publication
(10) Pub. No.: US 2025/0222398 A1
(43) Pub. Date: Jul. 10, 2025

(54) METHODS AND SYSTEMS OF EXTRACTING CARBON DIOXIDE FROM AIR

(71) Applicant: enVerid Systems, Inc., Westwood, MA (US)

(72) Inventors: Udi MEIRAV, Waban, MA (US); Christian WEEKS, Westwood, MA (US); Alex GOODWIN, Westwood, MA (US); Mike TOMOVICH, Westwood, MA (US); Shawn BROWN, Wakefield, MA (US)

(73) Assignee: enVerid Systems, Inc., Westwood, MA (US)

(21) Appl. No.: 19/012,824

(22) Filed: Jan. 7, 2025

Related U.S. Application Data
(63) Continuation of application No. PCT/US2023/069790, filed on Jul. 7, 2023.
(60) Provisional application No. 63/444,887, filed on Feb. 10, 2023.
(60) Provisional application No. 63/424,696, filed on Nov. 11, 2022.
(60) Provisional application No. 63/359,157, filed on Jul. 7, 2022.

(51) Int. Cl. B01D 53/62; B01D 53/047; B01D 53/96

(52) U.S. Cl. CPC B01D 53/62; B01D 53/0476; B01D 53/96; B01D 2257/504

(57) ABSTRACT

In some embodiments, a system for extraction of carbon dioxide (CO₂) from air is provided. In some embodiments, the system is configured to operate in at least two phases, a first absorption phase where CO₂ is adsorbed from an air stream by the system, and a second regeneration phase where adsorbed CO₂ is released and removed from the system using a vacuum. During the adsorption phase, air flows through a first chamber, which allows CO₂ to be captured by an adsorbent material therein. During a regeneration phase, the first chamber is evacuated, causing captured CO₂ to be released into an exhaust stream collected by a vacuum pump. In some embodiments, the system and/or controller is configured and/or programmed so that the regeneration phase is performed substantially without external heat or without substantially elevating the temperature of the adsorbent.

### RELATED APPLICATIONS

The subject disclosure claims benefit of and priority to each of U.S. application No. 63/359,157, filed Jul. 7, 2022, entitled, “METHODS AND SYSTEMS OF EXTRACTING CARBON DIOXIDE FROM AIR”, U.S. application No. 63/424,696, filed Nov. 11, 2022, entitled, “METHODS AND SYSTEMS OF EXTRACTING CARBON DIOXIDE FROM AIR”, and U.S. application No. 63/444,887, filed Feb. 10, 2023, entitled, “METHODS AND SYSTEMS OF EXTRACTING CARBON DIOXIDE FROM AIR”. Each of the foregoing disclosures is herein incorporated by reference in its entirety.

### FIELD OF THE DISCLOSURE

Embodiments of the present disclosure generally relate to capture of carbon dioxide (CO₂) from air, enabling removal of carbon dioxide (CO₂) from the atmosphere and potentially mitigating some of the effects associated with elevated atmospheric CO₂.

### BACKGROUND

The rising level of CO₂ in the atmosphere is a well-known concern, in particular in terms of its potential impact on climate. This has led to growing interest in methods of offsetting or reversing the rise in atmospheric carbon by selectively capturing large amounts of CO₂ and storing it or using it in ways that keep it out of the atmosphere. Some of these so-called carbon capture initiatives focus on capturing CO₂ near the point where they are generated, for example flue gas, namely emissions from fossil-fuel burning power plants; this approach has the advantage that the CO₂ is already fairly concentrated and therefore easier to capture selectively; on the other hand it requires significant changes to existing power plant facilities and cannot be used to address small, distributed sources of emissions, such as automobiles and home heating, let alone reduce CO₂ that has already been released into the atmosphere.

An alternative is direct air capture (DAC), where CO₂ is removed directly from ordinary atmospheric air. While it has the advantage of not requiring concentrated flue gas, it poses its own array of challenges, among them the need to separate the (very dilute) CO₂ in the atmosphere from large volumes of air and producing concentrated CO₂ which can then be stored or utilized.

Certain solid sorbents are known to have the ability to selectively capture CO₂ from an air mixture. All such sorbents have a certain capacity, namely a maximal amount of CO₂ that can be captured after which the sorbent is saturated can cannot capture any more CO₂. However, many of these sorbents have the further ability to undergo a cyclical regeneration process, where—after the capture of CO₂ on the sorbent surface—the CO₂ is released, and the sorbent can be used again. The release of CO₂ from a sorbent is ordinarily induced by a change in the temperature of the sorbent. This change in temperature requires a source of heat as well as a mechanism for heat transfer from the source to the sorbents. For meaningful impact on the atmosphere, a CO₂ capture solution in general, and in particular for DAC, needs to minimize the cost of the system and its operation, and be scalable so as to contend with large volumes of air.

### SUMMARY OF AT LEAST SOME EMBODIMENTS/ASPECTS

In some embodiments (embodiments may also be referred to as aspects of the disclosure, and/or aspects of a particular configuration of elements), a system for extraction of carbon dioxide (CO₂) from air is provided. In some embodiments, the system is configured to operate in at least two phases, a first absorption phase where CO₂ is adsorbed from an air stream by the system, and a second regeneration phase where adsorbed CO₂ is released and removed from the system using a vacuum. In some embodiments, the system includes a first chamber containing an adsorbent material for adsorption of CO₂, at least one inlet port (and in some embodiments only a single inlet port, in some embodiments, two or more inlet ports) allowing air to enter the first chamber during the first phase, at least one outlet port (and in some embodiments only a single outlet port, in some embodiments, two or more outlet ports) allowing air to exit the first chamber during the first phase, a vacuum port allowing gas to be pumped out of the first chamber during the second phase, one or a plurality of shutters and/or dampers configured to open and/or to seal the inlet and outlet ports, one or more vacuum components (in some embodiments, only one component), including at least one vacuum pump, configured to evacuate the first chamber through the vacuum port, and a controller configured to control operating the system in each phase by controlling one or more of the shutters and/or any of the vacuum components. In some embodiments, during the adsorption phase, air flows through the first chamber, allowing CO₂ to be captured by the adsorbent material. In some embodiments, during the regeneration phase, the first chamber is evacuated, causing captured CO₂ to be released into an exhaust stream collected by the pump. In some embodiments, the system and/or controller is configured and/or programmed so that the regeneration phase is performed substantially without external heat or without substantially elevating the temperature of the adsorbent.

At least some of the above noted embodiments, can include one and/or another (it a plurality, if not mutually exclusive) of the following features, functionality, structure, steps, or clarifications (and in some embodiments, two or more of, and in some embodiments, a majority of, in some embodiments, substantially all of, and in some embodiments, all of), yielding yet further embodiments:
a third purge phase that occurs between the adsorption and regeneration phase, such that:
the inlet and outlet are sealed and air is pumped out of the first chamber;
conduits/paths and vacuum components are configured so that the air pumped during the purge phase is substantially directed to a different path than the air during the regeneration phase;
configuring the system so that during the regeneration phase, at least one inlet allows a controlled amount of dilutive air to enter the first chamber and mix with the released CO₂ inside the first chamber, such that the CO₂ concentration is maintained below a desired level, where, in some embodiments, the amount of dilutive air is greater than the amount of CO₂, resulting in a CO₂ concentration that is less than 50%;
the exhaust stream from the first chamber is directed to a secondary chamber that uses a sorbent in a cyclical adsorption and regeneration process to produce an exhaust stream from the secondary chamber, during its respective regeneration stage, with a higher concentration of CO₂ than the exhaust of the first chamber;
a first pump is configured to perform the purge phase;
one or more other pumps can be used to perform the regeneration phase;
the adsorbent material is a bed of granular solid configured so that the air is forced to flow through the bed;
and
the adsorbent material is a plurality of sheets or monoliths.

In some embodiments, a method for extraction of carbon dioxide (CO₂) from air via an extraction system configured to operate in at least two distinct phases, a first phase (“adsorption”) where CO₂ is adsorbed from an air stream by the system, and a second phase (“regeneration”) where adsorbed CO₂ is released and removed from the system using vacuum. In some embodiments, the system includes a first chamber containing an adsorbent material for adsorption of CO₂, at least one inlet port allowing air to enter the first chamber during the first phase, at least one outlet port allowing air to exit the first chamber during the first phase, a vacuum port allowing gas to be pumped out of the first chamber during the second phase, a plurality of shutters or dampers configured to open or to seal the inlet and outlet ports, a plurality of vacuum components, including at least one vacuum pump, configured to evacuate the first chamber through the vacuum port, and a control system configured to control the phase of operation by controlling the shutters or any of the vacuum components, According, the method includes during the adsorption phase, flowing air through the first chamber, allowing CO₂ to be captured by the adsorbent material, and during the regeneration phase, evacuating the first chamber so as to cause CO₂ captured by the adsorbent is released into an exhaust stream collected by the vacuum pump. In some embodiments, the regeneration phase is performed substantially without external heat or without substantially elevating the temperature of the adsorbent.

At least some of the above noted embodiments, can include one and/or another (it a plurality, if not mutually exclusive) of the following features, functionality, structure, steps, or clarifications (and in some embodiments, two or more of, and in some embodiments, a majority of, in some embodiments, substantially all of, and in some embodiments, all of), yielding yet further embodiments:
sealing the inlet and outlet and pumping air out of the chamber during a third purge phase,
one or more conduits or airflow paths, and/or vacuum elements are configured so that the air pumped during the purge phase is substantially directed to a different path than the air during the regeneration phase;
allowing a controlled amount of dilutive air to enter the chamber and mix with the released CO₂ inside the chamber, thereby maintaining the CO₂ concentration below a desired level during the regeneration phase via at least one inlet;
the amount of dilutive air is greater than the amount of CO₂, resulting in a CO₂ concentration that is less than 50%;
directing the exhaust stream from the first chamber to a secondary chamber that uses a sorbent in a cyclical adsorption and regeneration process to produce an exhaust stream from the secondary chamber, during its respective regeneration stage, with a higher concentration of CO₂ than the exhaust of the primary chamber;
a first pump is configured to perform the purge phase, and one or more other pumps are used to perform the regeneration phase;
the adsorbent material comprising a bed of granular solid configured so that the air is forced to flow through the bed;
and
the adsorbent material is a plurality of sheets or monoliths.

The above noted embodiments/aspects further detailed below as well as the figures of the subject application, a brief description of which follows.

### BRIEF DESCRIPTION OF THE DRAWINGS

FIG. 1 shows a schematic side, cross-sectional view of a system for capture of CO₂ from an air stream via adsorption and release said captured CO₂ via vacuum regeneration, according to some embodiments of the disclosure.

FIG. 2 shows a schematic side, cross-sectional view of a two-stage system including a primary module and a secondary module, according to some embodiments of the disclosure.

FIG. 3 shows a schematic side, cross-sectional view of another system for capture of CO₂ from an air stream via adsorption and release said captured CO₂ via vacuum regeneration, according to some embodiments of the disclosure.

FIG. 4 is a schematic side, cross-sectional view of a CO₂ capture system including two separate modules for switching independently between adsorption and regeneration, according to some embodiments of the disclosure.

FIG. 5 is a schematic cross-sectional view of three (3) units operating in parallel, according to some embodiments of the present disclosure.

FIG. 6 is a schematic, cross-sectional view of a system which includes a purge seal and a purge line, connected to a purge pump, according to some embodiments of the disclosure.

### DETAILED DESCRIPTION OF AT LEAST SOME EMBODIMENTS/ASPECTS

It has been observed that a significant limitation of using heat for sorbent regeneration, beyond its requirement of a substantial amount of energy, is that it also requires a heat exchange mechanism—for example, radiation, conduction, or convection by an ambient gas. None of these lend themselves readily to a satisfactory solution. Radiation is complex to generate and very difficult to deliver and apply uniformly on a large scale; it is also susceptible to losses, inefficiencies and safety hazards. Most sorbent have very poor heat conduction, all but ruling out a large scale, simple solution based on conduction. Convection poses a different challenge. it does provide good heat transfer, but using such a convection gas during the desorption process causes that gas to mix with the outgassing CO₂, thereby undermining the collection of pure CO₂.

Accordingly, the present disclosure presents alternatives thereto that allows cyclical regeneration of the sorbent without heating the sorbent. It is generally the case that, without elevating the adsorbent temperature, the amount of CO₂ released over each regeneration cycle may be substantially reduced relative to thermally assisted regeneration. However, eliminating the heating requirement greatly simplifies the system, saves substantial energy, and greatly reduces the time duration of the regeneration process, thus potentially offsetting the reduced CO₂ capacity per cycle by enabling a significantly larger number of such cycles per day. Once all these considerations are factored in, this approach may result in a lower cost per ton of CO₂ captured, which in some embodiments is the metric of interest.

Accordingly, in some embodiments of the disclosure, a sorbent is used repeatedly to capture CO₂ from an air stream and subsequently regenerated by the release of some of the captured CO₂ to a collection system without requiring (or, in some embodiments, substantially without requiring)—either a source of heat or controlling the temperature during regeneration. The release of CO₂ is induced primarily by creating at least a partial vacuum around the sorbent, and the outgassed CO₂ is collected by one or more pumps that serve to create and maintain the required vacuum. In some embodiments, the CO₂ is further directed to a collection system comprising of conduits and storage vessels. The absence of a heating mechanism represents a tradeoff, where the regeneration is less efficient or comprehensive, but the speed and frequency of the adsorption and regeneration cycles is increased, while at the same time also allowing a significant simplification of the system, less energy consumption, and a reduced cost.

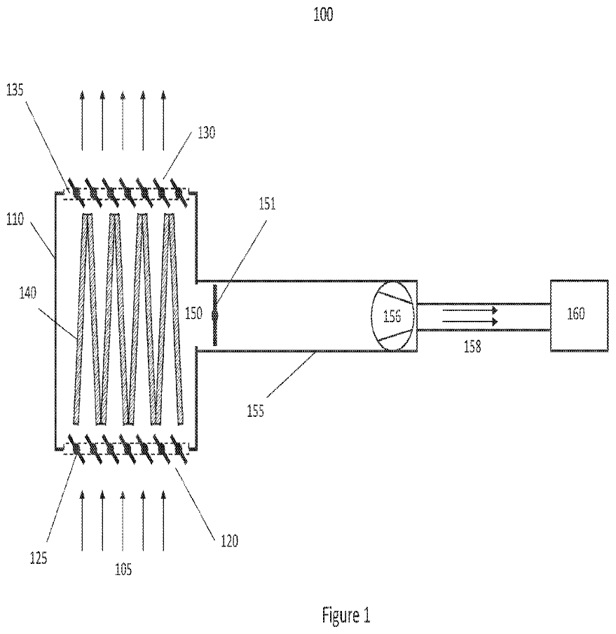

FIG. 1 shows a schematic side view cross section of an embodiment of the system 100 configured to capture CO₂ from an air stream via adsorption and subsequently release it with vacuum regeneration. During adsorption, a stream of air 105 enters a chamber 110 (first chamber, which in some embodiments, may be referred to as a module) through an inlet 120 (which can also be referred to as an inlet port throughout out the disclosure), flowing through one or more adsorbent elements 140 and exiting through an outlet 130 (which can also be referred to as an outlet port throughout out the disclosure). Both inlet and outlet are configured with a plurality of movable shutters 125 for the inlet shutter and 135 for the outlet shutter. The shutters can be of any suitable type, including but not limited to dampers, valves, flaps and the like, and the term shall be understood to imply any type of shutter. The shutters can be open as shown in FIG. 1, thereby allowing air flow through the chamber 110, or closed, thus sealing the chamber and allowing it to be substantially evacuated. The shutters may be further controlled by a mechanical actuator (not shown), which may further be controlled by a controller (e.g., a processor).

In some embodiments, the chamber is further configured with at least one, and preferably a plurality of vacuum components, which can include a separate vacuum port 150 that is connected to a conduit 155 that leads to a vacuum pump 156, and can also further lead to a CO₂ processing or collection subsystem 160. Accordingly, in some embodiments, during adsorption the vacuum port is sealed with the help of an electromechanically actuated shutter 151. In such embodiments, during regeneration, inlet and outlet shutters, 125 and 135, are both sealed, whereas the vacuum port 150 is open, the pump 156 is operational, and the chamber is evacuated (in some embodiments, continually evacuated). This results in a reduction of the partial pressure of all gases in the chamber including CO₂. The reduced partial pressure of CO₂ induces desorption and release of some of the CO₂ molecules that have been previously captured by the adsorbent 140, and the released CO₂ is carried away, along with any other gases desorbed from the sorbent or otherwise present in the chamber, in an exhaust stream 158 that flows through the vacuum port 150 and the conduit 155 to the pump 156 and subsequently to the collection system 160.

In some embodiments, order to achieve optimal pumping performance and efficiency, two or more pumps may be operated in series; for example, a high vacuum pump with a backing pump. It will be understood that in all descriptions of the invention herein, including all the attached figures, the term “pump” is to be understood as including the possibility of a plurality of pumps in series.

The duration of adsorption is limited by the eventual saturation of the sorbent and is influenced by numerous system properties, including but not limited to the intrinsic properties of the adsorbent, as well as the composition and temperature of the air, the rate of air flow, the amount of sorbent deployed and the physical design of the system.

Similarly, the regeneration process depends on various factors including but not limited to the underlying properties of the adsorbent, the degree of saturation achieved, the induced vacuum level and the pumping capabilities, the temperature, the physical configuration of the sorbent and the design of the system.

Accordingly, in some embodiments, the system switches cyclically from an adsorption phase to a regeneration phase. In some embodiments, the duration of each phase is determined by a controller (e.g., a computer, a programmable controller, a processor) to achieve the required performance. In some embodiments, the switching need not necessarily correspond to the complete saturation or complete regeneration of the sorbent and may be selected to address other considerations, as will become clearer below.

In some embodiments, the concentration of CO₂ in the exhaust stream is sufficient for subsequent disposition, which can be any form of storage, shipping or utilization. In other embodiments it is necessary to increase the CO₂ concentration before such disposition. Any suitable technique for increasing concentration can be implemented. In some embodiments, a similar approach to that used for the initial capture and concentration of CO₂ can be repeated as a secondary concentration stage, where the exhaust of first stage system is the input to the second stage system, namely a secondary concentrator/module.

The secondary concentrator module may have substantially different design and operating schedule than a first/initial/primary module (which may also be referred to as a stage), differences representing any of a number or reasons and considerations. In some embodiments, the secondary module is substantially smaller, as the output volume of the first stage is significantly smaller than its input. In some embodiments, the secondary module is shared by a plurality of primary modules, whose exhaust streams are combined into the same secondary module.

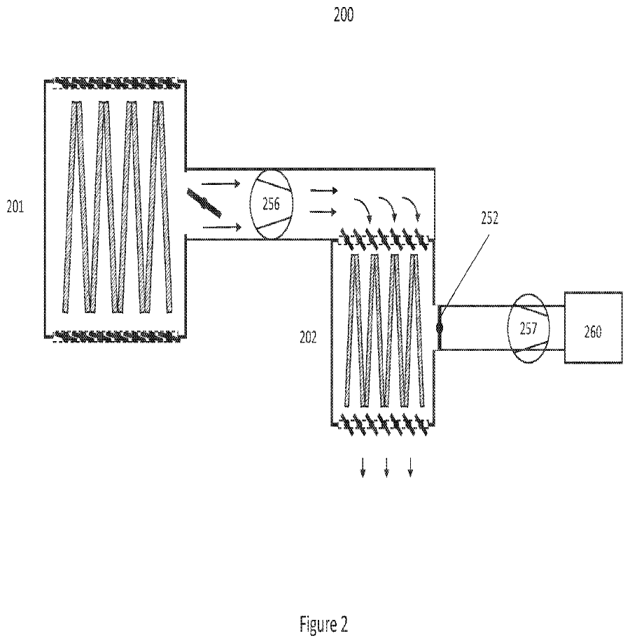

FIG. 2 schematically depicts a two-stage system comprising a primary module 201 (which in some embodiments, can be referred to as a chamber) and a secondary module 202 (which in some embodiments, can be referred to as a chamber). The figure corresponds to the regeneration state of the first module, where the first-stage pump 256 draws a vacuum on the primary module and streams the exhaust into the secondary module. The latter has its main inlet and outlet open, allowing the first stage exhaust to flow through the sorbent media in the secondary module. When the secondary module is saturated or otherwise ready for regeneration. the main inlet and outlet shutters are closed (not shown in this figure), the secondary vacuum outlet shutter 252 is open (not shown in this figure) and air is collected by the secondary vacuum pump 257 and conveyed to a collection system 260 for storage or utilization.

The principles of the two-stage system can be extended to more than stages. In a 3-stage system the exhaust from the secondary module becomes the input to a tertiary module, etc. Multi-stage systems can be designed for optimizing the performance and economics of the system by loosening the requirements on each stage, including but not limited to the vacuum level required, the pumping throughput and specifications, duration of each cycle, the energy use and the mechanical specification of the system.

In some embodiments, the system is configured to allow for a certain amount of air to flow into the chamber during regeneration. This air is allowed to mix with the desorbed gas molecules, which include but are not limited to CO₂, thereby diluting the concentration of the latter in the exhaust stream that is collected by the vacuum pump(s). However the lower concentration of CO₂ can enable better desorption and displacement of CO₂ even with a less stringent level of vacuum. The resulting exhaust has a lower concentration of CO₂, but a secondary concentrator as described above can be used to bring the CO₂ to the concentration level required by the collection system. This influx of air during the vacuum regeneration may be referred to as dilution air (as it dilutes the desorbed CO₂) or sweep air (as it sweeps the desorbed CO₂ towards the vacuum pump). Accordingly, in some embodiments, the CO₂ concentration can then be less than 70%, less than 65%, less than 55%, less than 50%, less than 45%, less than 40%, less than 35%, less than 30%, less than 25%, less than 20%, less than 15%, less than 10%, or less than 5%.

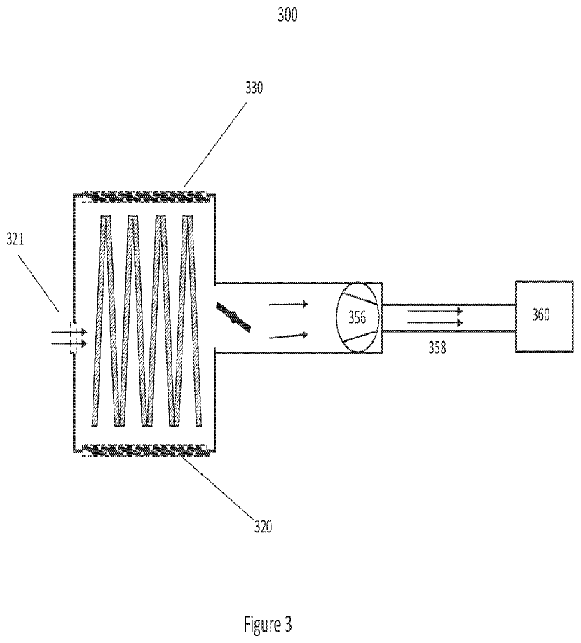

FIG. 3 schematically depicts a system similar to that of FIG. 1, with the inlet and outlet shutters in a closed position, and the vacuum outlet open—namely, in the vacuum-regeneration state. In such an embodiment, the system is further configured with an inlet 321 for the influx of dilution-air. In some embodiments, the inlet is permanently open, whereas in other embodiments (not shown) it is configured with a controllable shutter that is open during regeneration. The location of the inlet 321 can be anywhere on the chamber; in one embodiment it is located opposite from the vacuum outlet, so that the sweep air largely flows across the sorbent towards the outlet, and in doing so displaces the desorbed CO₂ as well.

In some embodiments, rather than using a separate inlet 321, the primary inlet 320 and/or outlet 330 can serve the purpose. In this type of embodiment, the corresponding shutters, when positioned for regeneration, are not hermetically sealed; rather, they are configured to allow the amount of flow intended as a sweep air or dilutive air to enter the cabinet as required.

The adsorbent element can be made of any suitable solid, granular, fibrous or sheet material with appropriate adsorption properties. In a typical embodiment the adsorbent material (or “sorbent”), will be a material with preferential adsorption of CO₂ relative to its adsorption of other components of air, including oxygen and nitrogen. Many such CO₂ adsorbents are known in the art. Some CO₂ adsorbents comprise amine-based compounds, including but not limited to ethanol-amines (for example, monoethanolamine, MEA and diethanolamine or DEA) and ethylene-amines, e.g., tetraethylene pentamine (TEPA) or pentaethylene hexamine (PEHA), polyamine mixes, as well as various amine polymers such a polyethylenimine (PEI). Other potential sorbents include natural and synthetic zeolites, silica (fumed, precipitated, etc.), alumina- and other metal oxides, porous minerals, synthetic metal organic framework (MOF) compounds and various forms of carbon, activated charcoal, graphite, graphene, carbon nanotubes, and carbon black. The adsorbent materials may also comprise ion exchange resins, polymeric absorbent resins, acrylic ester polymers, polystyrene divinyl benzene, polymethyl methacrylate (PMMA), polystyrene, styrene divinylbenzene (SDB), fly ash, and various aluminum phyllosilicates including but not limited to clay, bentonite, montmorillonite, ball clay, fuller's earth, kaolinite, attapulgite, hectorite, palygorskite, saponite, and sepiolite, for example.

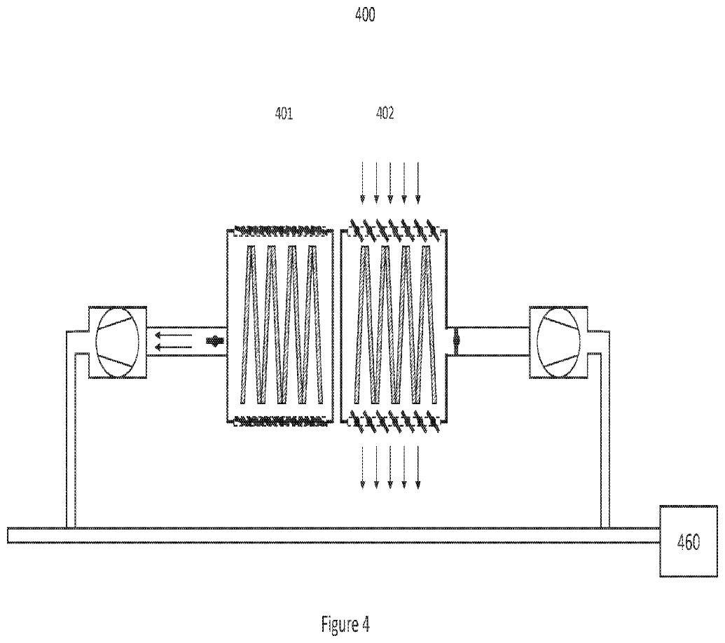

FIG. 4 is a schematic depiction of a CO₂ capture system, according to some embodiments, comprising two separate modules labeled 401 and 402, each of which can switch independently between adsorption and regeneration. Separating the CO₂ subsystem into multiple modules allows for some of them to be operational in capturing CO₂ while others are undergoing regeneration at the same time. The embodiment depicted in this figure shows each unit having a separate pump. In other embodiments several units can share the same physical pump, each having a separate conduit or path (as illustrated) to that pump with an independent shutter or valve that opens only when the unit is ready for regeneration.

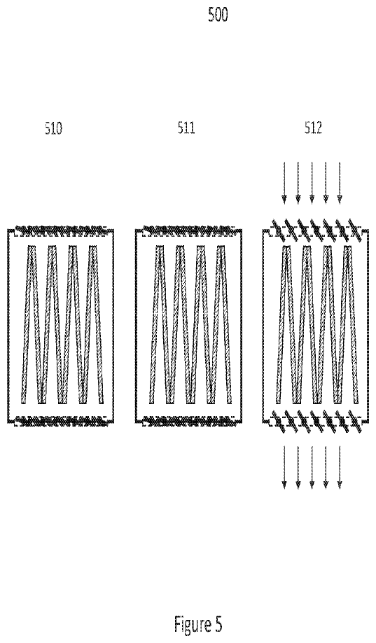

In some embodiments, more than two such units can be configured in parallel, and the phasing of their operating modes can be staggered. For example, FIG. 5 shows three units—labeled 510, 511 and 512—operating in parallel. In an illustrative, nonlimiting example, the regeneration cycle can take 20 minutes while the adsorption only takes half as long, 10 minutes; a three-module configuration like the one shown in FIG. 5 allows a staggered cycle where for a predetermined period of time (e.g., every 10 minutes) a different module begins adsorption while one unit continues regeneration and the third begins regeneration. Any other number of units or scheduling sequence can be implemented along these general lines to achieve the desired performance based on the characteristic times required for completing adsorption and regeneration. Each system, accordingly, has a chamber with an adsorbent (according to some embodiments). Thus, a second system operating in parallel (or in some embodiments, in series) with a first system, and can be said to have a secondary chamber, and a third connected system can be said to have a tertiary chamber.

In some embodiments, at the end of adsorption, when the inlet and outlet are sealed but before evacuation begins, the chamber is full of air. This means that at the beginning of regeneration the gas being removed from the chamber is not appropriate for CO₂ collection, but rather should be discharged. This can be facilitated by introducing a purge phase during an initial period of the regeneration, where air is pumped from the chamber but discharged rather than collected.

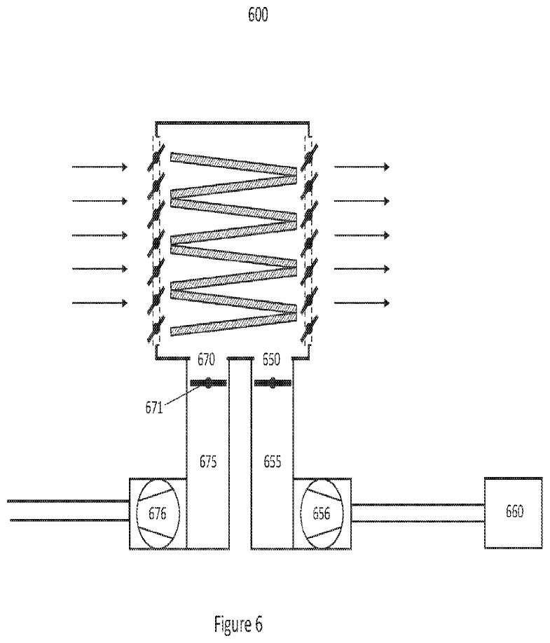

Accordingly, FIG. 6 depicts an embodiment where this can be achieved using a separate purge outlet 670 configured with a purge seal 671 and a purge line 675 connected to a purge pump 676. At the beginning of regeneration, after sealing the inlet 620 and the outlet 630, the purge seal 671 is open and the purge line 675 is pumped for a certain duration of time, allowing the purge pump 676 to remove most of the residual air left in the chamber at the end of the adsorption phase. At that point, the seal 671 is closed and the main regeneration path through the vacuum port 650 is opened, and the main pump 656 evacuates the chamber (in some embodiments, continually evacuated).

In some embodiments both purge and vacuum lines use the same port 650 in the chamber. The evacuation line can branch into two separate pumps, one for purge and the other for collection (for example).

In some embodiments, the same pump is used for purge and for collection of CO₂, for example by using a 3-way valve behind the regeneration pump; the valve initially sends the air downstream from the back of the pump to an appropriate purge outlet; subsequently, when purge is complete, it redirect the air to a collection system.

In some embodiments, the use of a separate purge pump 676 allows the section between the regeneration seal 651 and the regeneration pump 656 to be kept under vacuum at all times, including during adsorption and purge, as the seal 651 maintains that space under vacuum. In some embodiments, the pump 656 thus operates, in some embodiments, without having to stop or restart between phases. In some embodiments, thus maintaining the pump 656 under continuous vacuum operation may be beneficial for the operation of the pump.

In some multi-stage systems, according to some embodiments (e.g., such as those described above and in FIG. 2), a purge pump may not be necessary for the primary stage, where the exhaust concentration is not very high, but only applied to a subsequent (secondary, tertiary etc.) stage.

In some embodiments, there is a plurality of pumps in series, or a compressor between the pump and the CO₂ collection system. In these configurations the secondary pump or compressor enable the first pump to provide better performance, for example in terms of higher flow throughput, reduced backflow, or lower residual pressure (“higher vacuum”).

In some embodiments, CO₂ processing system 160 can be in any suitable location. In some embodiments, it is nearby and serving only a small number or nearby systems, whereas in some embodiments, it can be more remote, requiring longer conduits or other forms of transport, and can shared by a larger number of CO₂ collection units. The processing system 160 may prepare the CO₂ for efficient storage by any suitable mechanism. In some embodiments, the CO₂ is compressed or liquified so that it can be shipped more economically to the location where the gas is to be further processed or stored. In some embodiments, the CO₂ can be converted chemically to a solid or liquid compound that allows easier transport or storage. Yet in some embodiments, the CO₂ is conveyed by a network of conduits shared by a plurality of systems which carry the CO₂ to a centralized processing facility.

In some embodiments, the effectiveness of the solution may depend in part on the rate of desorption of CO₂ in vacuum for the sorbent in use and the conditions under which it is used. While it is generally the case that an elevated temperature leads to rapid desorption, heating the sorbent introduces a substantial operational expense and system complication. In general, some CO₂ desorption is possible at almost any temperature, as long as the ambient partial pressure of CO₂ is low enough on other words, inducing and maintaining a sufficiently high vacuum. As CO₂ is released, it needs to be pumped away at a rate that is high enough so as to maintain the requirement, otherwise desorption will halt. The targeted vacuum level dictates, among other things, a system design and construction that provides the required pumping capacity, in terms of the pumps themselves as well as appropriately sized conduits connecting the pump to the chamber.

Even with high vacuum maintained, the kinetics of desorption, and therefore the regeneration rate, can be sensitive to temperature. In some embodiments this implies, that absent a heating mechanism, the regeneration may take longer time. It may also mean that a higher level of vacuum—lower residual pressure—may be necessary, which has implications for pump requirements and the engineering of the systems apertures and seals.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that any and all parameters, dimensions, materials, and configurations described herein are meant to be an example and that the actual parameters, dimensions, materials, and/or configurations will depend upon the specific application or applications for which the inventive teachings disclosed herein is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the claims supported by the disclosure, and equivalents thereto, inventive embodiments may be practiced otherwise than as specifically described and claimed. Inventive embodiments of the present disclosure are also directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

Embodiments disclosed herein may also be combined with one or more features, as well as complete systems, devices and/or methods, to yield yet other embodiments and inventions. Moreover, some embodiments, may be distinguishable from the prior art by specifically lacking one and/or another feature disclosed in the particular prior art reference(s); i.e., claims to such embodiments are distinguishable from the prior art by including one or more negative limitations.

Also, various inventive concepts may be embodied as one or more methods, of which examples has been provided. The acts performed as part of the method may be ordered in any suitable way. Accordingly, embodiments may be constructed in which acts are performed in an order different than illustrated, which may include performing some acts simultaneously.

The indefinite articles “a” and “an,” as used herein in the specification and in the claims, unless clearly indicated to the contrary, should be understood to mean “at least one.” The terms “can” and “may” are used interchangeably in the present disclosure, and indicate that the referred to element, component, structure, function, functionality, objective, advantage, operation, step, process, apparatus, system, device, result, or clarification, has the ability to be used, included, or produced, or otherwise stand for the proposition indicated in the statement for which the term is used (or referred to) for a particular embodiment(s).

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A system for extraction of carbon dioxide (CO₂) from air, where the system is configured to operate in at least two phases,
a first absorption phase where CO₂ is adsorbed from an air stream by the system, and
a second regeneration phase where adsorbed CO₂ is released and removed from the system using a vacuum,
the system comprising:
a first chamber containing an adsorbent material for adsorption of CO₂;
at least one inlet port allowing air to enter the first chamber during the first phase;
at least one outlet port allowing air to exit the first chamber during the first phase;
a vacuum port allowing gas to be pumped out of the first chamber during the second phase;
one or a plurality of shutters and/or dampers configured to open and/or to seal the inlet and outlet ports;
one or more vacuum components, including at least one vacuum pump, configured to evacuate the first chamber through the vacuum port; and
a controller configured to control operating the system in each phase by controlling one or more of the shutters and/or any of the vacuum components;
wherein:
during the adsorption phase, air flows through the first chamber, allowing CO₂ to be captured by the adsorbent material,
during the regeneration phase, the first chamber is evacuated, causing captured CO₂ to be released into an exhaust stream collected by the pump, and
the system and/or controller is configured and/or programmed so that the regeneration phase is performed substantially without external heat or without substantially elevating the temperature of the adsorbent.

2. The system of claim 1, wherein the system is further configured for a third purge phase that occurs between the adsorption and regeneration phase, such that:
the inlet and outlet are sealed and air is pumped out of the first chamber, and
conduits/paths and vacuum components are configured so that the air pumped during the purge phase is substantially directed to a different path than the air during the regeneration phase.

3. The system of claim 1, wherein the system is further configured so that during the regeneration phase, at least one inlet allows a controlled amount of dilutive air to enter the first chamber and mix with the released CO₂ inside the first chamber, such that the CO₂ concentration is maintained below a desired level.

4. The system of claim 3, wherein the amount of dilutive air is greater than the amount of CO₂, resulting in a CO₂ concentration that is less than 50%.

5. The system of claim 1, wherein the exhaust stream from the first chamber is directed to a secondary chamber that uses a sorbent in a cyclical adsorption and regeneration process to produce an exhaust stream from the secondary chamber, during its respective regeneration stage, with a higher concentration of CO₂ than the exhaust of the first chamber.

6. The system of claim 1, wherein a first pump is configured to perform the purge phase, and one or more other pumps are used to perform the regeneration phase.

7. The system of claim 1, wherein the adsorbent material is a bed of granular solid configured so that the air is forced to flow through the bed.

8. The system of claim 1, wherein the adsorbent material is a plurality of sheets or monoliths.

9. A method for extraction of carbon dioxide (CO₂) from air via an extraction system configured to operate in at least two distinct phases,
a first phase (“adsorption”) where CO₂ is adsorbed from an air stream by the system, and
a second phase (“regeneration”) where adsorbed CO₂ is released and removed from the system using vacuum,
the system comprising:
a first chamber containing an adsorbent material for adsorption of CO₂;
at least one inlet port allowing air to enter the first chamber during the first phase;
at least one outlet port allowing air to exit the first chamber during the first phase;
a vacuum port allowing gas to be pumped out of the first chamber during the second phase;
a plurality of shutters or dampers configured to open or to seal the inlet and outlet ports;
a plurality of vacuum components, including at least one vacuum pump, configured to evacuate the first chamber through the vacuum port; and
a control system configured to control the phase of operation by controlling the shutters or any of the vacuum components;
the method comprising:
during the adsorption phase, flowing air through the first chamber, allowing CO₂ to be captured by the adsorbent material,
during the regeneration phase, evacuating the first chamber so as to cause CO₂ captured by the adsorbent is released into an exhaust stream collected by the vacuum pump,
wherein the regeneration phase is performed substantially without external heat or without substantially elevating the temperature of the adsorbent.

10. The method of claim 9, further comprising sealing the inlet and outlet and pumping air out of the chamber during a third purge phase, wherein one or more conduits or airflow paths, and vacuum elements are configured so that the air pumped during the purge phase is substantially directed to a different path than the air during the regeneration phase.

11. The method of claim 9, further comprising allowing a controlled amount of dilutive air to enter the chamber and mix with the released CO₂ inside the chamber, thereby maintaining the CO₂ concentration below a desired level during the regeneration phase via at least one inlet.

12. The method of claim 9, wherein the amount of dilutive air is greater than the amount of CO₂, resulting in a CO₂ concentration that is less than 50%.

13. The method of claim 9, further comprising directing the exhaust stream from the first chamber to a secondary chamber that uses a sorbent in a cyclical adsorption and regeneration process to produce an exhaust stream from the secondary chamber, during its respective regeneration stage, with a higher concentration of CO₂ than the exhaust of the primary chamber.

14. The method of claim 9, wherein a first pump is configured to perform the purge phase, and one or more other pumps are used to perform the regeneration phase.

15. The method of claim 9, wherein the adsorbent material comprising a bed of granular solid configured so that the air is forced to flow through the bed.

16. The method of claim 9, wherein the adsorbent material is a plurality of sheets or monoliths.

17. (canceled)
